(19) United States
(12) Patent Application Publication
(10) Pub. No.: US 2026/0361785 A1
(43) Pub. Date: Nov. 12, 2026

(54) METHOD AND APPARATUS FOR SHARING DATA BY USING ULTRA-WIDEBAND COMMUNICATION

(71) Applicant: Samsung Electronics Co., Ltd., Gyeonggi-do (KR)

(72) Inventors: Junyoung CHOI, Gyeonggi-do (KR); Yeonju LIM, Gyeonggi-do (KR)

(21) Appl. No.: 19/486,291

(22) PCT Filed: May 23, 2023
(86) PCT No.: PCT/KR2023/006994

§ 371 Date: Nov. 20, 2025

(51) Int. Cl. H04L 67/06; H04L 67/104; H04L 67/1042; H04W 28/18

(52) U.S. Cl. CPC H04L 67/06; H04L 67/1042; H04L 67/1044; H04W 28/18

(57) ABSTRACT

The present disclosure provides a method for operating a UWB channel together with an NB channel. A method of a first electronic device according to various embodiments of the present disclosure comprises the steps of: selecting at least one second electronic device to form a group, using ultra-wide band (UWB) ranging; transmitting, to the at least one second electronic device, a group creation confirmation request message in response to the group creation confirmation request message, using UWB communication; receiving, from the at least one second electronic device, a group creation response message, using UWB communication; creating a group including at least one third electronic device that has transmitted a response indicating acceptance of a group creation, based on the group creation response message; transmitting, to the at least one third electronic device, information on the created group, using UWB communication; and transmitting, to the at least one third electronic device included in the created group for data sharing, data, using neighbor awareness networking (NAN) based communication.

### CROSS-REFERENCE TO RELATED APPLICATIONS

This application is a U.S. National Phase Entry of PCT International Application No. PCT/KR 2023/006994, which was filed on May 23, 2023, the contents of which are incorporated herein by reference.

### TECHNICAL FIELD

The disclosure relates to device-to-device data sharing.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create new value in human life. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB).

### DETAILED DESCRIPTION OF THE INVENTION

### Technical Problem

The disclosure provides a method and device for providing a device-to-device data sharing service using UWB communication.

### Technical Solution

According to an embodiment of the disclosure, a method of a first electronic device includes selecting at least one second electronic device to form a group using UWB ranging; transmitting a group creation confirmation request message to the at least one second electronic device using UWB communication; receiving a group creation response message from the at least one second electronic device in response to the group creation confirmation request message using UWB communication; creating a group including at least one third electronic device that transmitted a response indicating acceptance of a group creation based on the group creation response message; transmitting information about the created group to the at least one third electronic device using UWB communication; and transmitting data to the at least one third electronic device included in the created group for data sharing using neighbor awareness networking (NAN) based communication.

According to an embodiment of the disclosure, a first electronic device includes a transceiver; and at least one processor. The at least one processor may be configured to select at least one second electronic device to form a group using UWB ranging, transmit a group creation confirmation request message to the at least one second electronic device using UWB communication, receive a group creation response message from the at least one second electronic device in response to the group creation confirmation request message using UWB communication, create a group including at least one third electronic device that transmitted a response indicating acceptance of a group creation based on the group creation response message, transmit information about the created group to the at least one third electronic device using UWB communication, and transmit data to the at least one third electronic device included in the created group for data sharing using NAN based communication.

According to an embodiment of the disclosure, a method of a second electronic device includes receiving, from a first electronic device, a group creation confirmation request message, using UWB communication, transmitting, to the first second electronic device, a group creation response message indicating acceptance of a group creation in response to the group creation confirmation request message, using UWB communication, receiving, from the first electronic device, information on a created group based on the group creation response message, using UWB communication, and receiving, from the first electronic device, data based on information on the created group, using neighbor awareness networking (NAN) based communication.

According to an embodiment of the disclosure, a second electronic device includes a transceiver; and at least one processor, wherein the at least one processor is configured to: receive, from a first electronic device, a group creation confirmation request message, using UWB communication; transmit, to the first second electronic device, a group creation response message indicating acceptance of a group creation in response to the group creation confirmation request message, using UWB communication; receive, from the first electronic device, information on a created group including the second electronic device based on the group creation response message, using UWB communication, and receive, from the first electronic device, data based on information on the created group, using neighbor awareness networking (NAN) based communication.

### Advantageous Effects

The disclosure provides a method and device for efficiently providing a device-to-device data sharing service using UWB communication.

The disclosure may improve data sharing speed and efficiency by forming a group of multiple devices when providing a device-to-device data sharing service using UWB communication, and by using an existing group and utilizing previously formed data paths during re-sharing.

### BRIEF DESCRIPTION OF DRAWINGS

FIG. 1 illustrates an example architecture of an electronic device according to an embodiment of the disclosure.

FIG. 2 illustrates a communication system including a plurality of electronic devices according to an embodiment of the disclosure.

FIG. 3 illustrates a method for performing communication by a plurality of electronic devices according to an embodiment of the disclosure.

FIG. 4 illustrates operations between electronic devices for initial Wi-Fi Aware connection according to an embodiment of the disclosure.

FIG. 5 is a view illustrating creating a device group for data sharing according to an embodiment of the disclosure.

FIG. 6 is a view illustrating operations for creating a device group for data sharing according to an embodiment of the disclosure.

FIG. 7 is a view illustrating operations in a transmitting device when creating a device group for data sharing according to an embodiment of the disclosure.

FIG. 8 is a view illustrating operations in a transmitting device and receiving device when creating a device group for data sharing according to an embodiment of the disclosure.

FIG. 9 is a view illustrating operations in a transmitting device and receiving device when creating a device group for data sharing according to an embodiment of the disclosure.

FIG. 10 is a view illustrating operations in a receiving device when creating a device group for data sharing according to an embodiment of the disclosure.

FIG. 11 is a view illustrating operations in a transmitting device and receiving device after acceptance of creation of a device group for data sharing according to an embodiment of the disclosure.

FIG. 12 is a view illustrating operations in a transmitting device and receiving device after acceptance of creation of a device group for data sharing according to an embodiment of the disclosure.

FIG. 13 is a view illustrating operations of a transmitting device and receiving device when creating a device group for data sharing and sharing data according to an embodiment of the disclosure.

FIG. 14 is a view illustrating operations of a transmitting device and receiving device when creating a device group for data sharing and sharing data according to an embodiment of the disclosure.

FIG. 15 is a view illustrating operations of a transmitting device and receiving device when creating a device group for data sharing and sharing data according to an embodiment of the disclosure.

FIG. 16 is a view illustrating operations for re-sharing data after creating a device group according to an embodiment of the disclosure.

FIG. 17 is a view illustrating operations for re-sharing data after creating a device group according to an embodiment of the disclosure.

FIG. 18 is a view illustrating operations for adding a new electronic device to a group after creating a device group according to an embodiment of the disclosure.

FIG. 19 illustrates a device diagram illustrating a transmitting device (first electronic device) according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the disclosure is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the present disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “. . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game devices with wireless communications capabilities, music storage and play back home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the disclosure are described in detail with reference to the accompanying drawings. Further, although a communication system using UWB is described in connection with embodiments of the disclosure, as an example, embodiments of the disclosure may also apply to other communication systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100m. WPAN is a technology based on IEEE 802.15 which includes Bluetooth, ZigBee, and ultra wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The exemplary embodiments are described below in relation to wireless local area network (WLAN) systems merely for simplicity. It should be understood that the exemplary embodiments are equally applicable to other wireless networks (e.g., cellular networks, pico networks, femto networks, satellite networks) as well as systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH®, HiperLAN (a set of wireless standards mainly used in Europe and comparable to IEEE 802.11 standards), and other technologies having relatively short wireless propagation ranges. Therefore, the terms “WLAN” and “Wi-Fi” may be used interchangeably herein. Further, while an infrastructure WLAN system including one or more access points (APs) and multiple wireless stations (STAs) is described below, the exemplary embodiments are equally applicable to other WLAN systems including, e.g., multiple WLANs, peer-to-peer (or independent basic service set) systems, Wi-Fi Direct systems and/or hotspots.

Further, while the exchange of data frames between wireless devices is described herein, the exemplary embodiments may be applied to the exchange of any data unit, packet and/or frame between wireless devices. Therefore, the term “frame” may include any frame, packet, or data unit such as, e.g., protocol data units (PDUs), media access control (MAC) protocol data units (MPDUs), and physical layer convergence procedure protocol data units (PPDUs). The term “A-MPDU” may mean aggregated MPDUs.

In the following description, numerous specific details are set forth, such as examples of specific components, circuits, and processes, to provide a thorough understanding of the disclosure. The term “connected” used herein means directly connected or connected through one or more intervening components or circuits.

Further, in the following description and for purposes of description, specific nomenclature is set forth to provide a thorough understanding of the exemplary embodiments. However, it is apparent to those skilled in the art that these specific details may not be necessary to practice the exemplary embodiments. In other instances, well-known circuits and devices are illustrated in block diagram form to avoid obscuring the disclosure.

Wi-Fi CERTIFIED Wi-Fi Aware™ (Wi-Fi Aware) is a technology that extends the capabilities of Wi-Fi by enabling rapid discovery, connection, and data exchange with other Wi-Fi devices without the need for traditional network infrastructure, Internet connection, or GPS signals. Wi-Fi aware may provide the function of enabling a mutual search and direct connection between devices even without any other type of connection. Wi-Fi aware may also be referred to as neighbor awareness networking (NAN).

Wi-Fi aware networking may work by forming a cluster with a peripheral device or by creating a new cluster if the device is the first device in the area. An application may communicate with a Wi-Fi aware system service that manages the device's Wi-Fi aware hardware using an application programming interface (Wi-Fi aware API). For example, a Wi-Fi aware network connection may support higher processing speeds over long distances where Bluetooth connections are not reachable. For example, the Wi-Fi aware network connection may be useful for apps that share large amounts of data between users, such as photo-sharing apps.

Bluetooth low energy (BLE) refers to a technology that operates at lower power than conventional Bluetooth (or Bluetooth classic) and may be used in electronic devices such as smart bands, watches, and beacons, for example.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

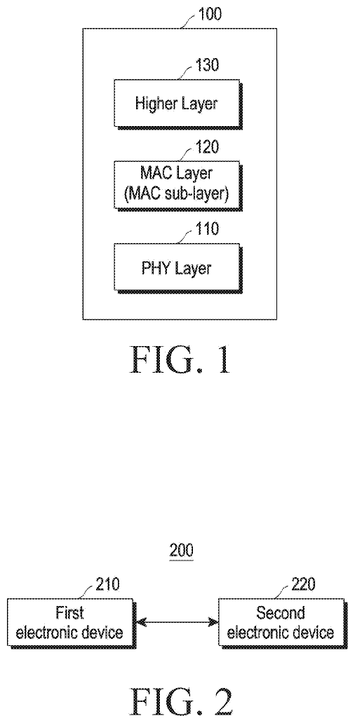

FIG. 1 illustrates an example architecture of an electronic device according to an embodiment of the disclosure.

In the disclosure, the electronic device may be one of various types of electronic devices. For example, the electronic device may be a portable device (e.g., a UE, a smartphone, a wearable device, a vehicle, or a tag device) or a stationary device (e.g., a door lock or an anchor device).

Referring to FIG. 1, the electronic device 100 may include a PHY layer 110, a MAC layer (MAC sublayer) 120, and/or a higher layer 130.

### (1) PHY Layer

The PHY layer 110 may include a low-level control entity and at least one transceiver. In this disclosure, the transceiver may be referred to as an RF transceiver or a radio transceiver.

As an embodiment, at least one transceiver may include a first transceiver supporting UWB communication (e.g., 802.15.4z-based UWB communication), a second transceiver supporting NB communication using a narrower bandwidth than that of UWB communication, and/or a third transceiver supporting other communication technologies (e.g., Wi-Fi or BLE). In this disclosure, the first transceiver may be referred to as a UWB transceiver. The second transceiver may be referred to as an NB transceiver. The third transceiver may be referred to as an out-of-band (OOB) transceiver. According to embodiments, one transceiver may support a plurality of communication technologies. For example, one transceiver may support UWB communication and NB communication.

In an embodiment, the PHY layer 110 may support at least one of the following functions.
Transceiver activation and deactivation function (transceiver on/off function)
Energy detection function
Channel selection function
Clear channel assessment (CCA) function
Synchronization function
Low-level signaling function
UWB ranging, positioning and localization functions
Spectrum resource management function
Function to transmit/receive packets through physical medium

### (2) MAC Layer

The MAC layer 120 provides an interface between the higher layer 130 and the PHY layer 120.

In an embodiment, the MAC layer 120 may provide two services as follows.
MAC data service: A service that enables transmission and reception of MAC protocol data unit (PDU) through the PHY
MAC management service: Service interfacing to MAC sublayer management entity (MLME) service access point (SAP) (MLME-SAP)

In an embodiment, the MAC layer 120 may support at least one of the following functions.
Device discovery and connection setup function
Channel access function (function of access to physical channel (e.g., NB channel/UWB channel/OOB channel))
Synchronization function
Interference mitigation function based on energy detection
Functions related to NB signaling
Guaranteed timeslot (GTS) management function
Frame delivery function
UWB ranging function
PHY parameter change notification function
Security function

### (3) Upper Layer

The upper layer 130 may include a network layer providing functions, such as network configuration and message routing, and/or an application layer providing an intended function of the device. In an embodiment, the application layer may be a UWB-enabled application layer for providing a UWB service.

FIG. 2 illustrates a communication system including a plurality of electronic devices according to an embodiment of the disclosure.

Referring to FIG. 2, a communication system 200 may include a first electronic device 210 and a second electronic device 220. As an embodiment, the first electronic device 210 and/or the second electronic device 220 may be the electronic device 100 of FIG. 1.

The first electronic device 210 may communicate with the second electronic device 220 for device discovery, connection setup, ranging (e.g., UWB ranging), data communication, and/or other purposes.

The first electronic device 210 may communicate with the second electronic device 220 according to a preset communication scheme (technology). For example, the first electronic device 210 may perform wireless communication with the second electronic device 220 using a UWB communication scheme, an NB communication scheme, and/or an OOB communication scheme.

In the disclosure, the UWB communication scheme may perform communication through at least one of candidate UWB channels allocated for UWB communication.

NB communication may support at least one NB channel having a narrower bandwidth than the UWB channel. In an embodiment, the NB channel may be a subchannel of one of the candidate UWB channels allocated for UWB communication. In an embodiment, the NB channel may be a subchannel of at least one of the channels allocated for wireless communication other than UWB communication.

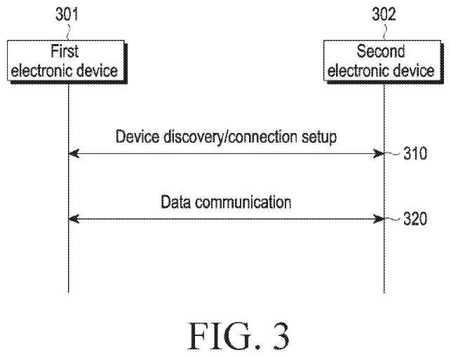

FIG. 3 illustrates a method for performing communication by a plurality of electronic devices according to an embodiment of the disclosure.

The first electronic device 301 and the second electronic device 302 of FIG. 3 may be, e.g., the electronic devices of FIG. 1 or 2.

Referring to FIG. 3, the first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### (1) Device Search/Connection Setup Procedure

In the disclosure, the device search/connection setup procedure 310 may be a prior procedure performed before the data communication procedure 320. As an example, the device discovery/connection setup procedure 310 may be performed over OOB communication (channel), NB communication (channel), and/or UWB communication (channel).

The device search/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be referred to as a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controlee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.
UWB ranging operation: An operation in which the electronic device performs UWB ranging with another electronic device in a preset UWB ranging scheme (e.g., one-way ranging (OWR), SS-TWR (two-way ranging), DS-TWR (two-way ranging) scheme). As an embodiment, the UWB ranging operation may include a ToF measurement operation and/or an AoA measurement operation.
Transaction operation: An operation in which an electronic device exchanges service data with another electronic device.

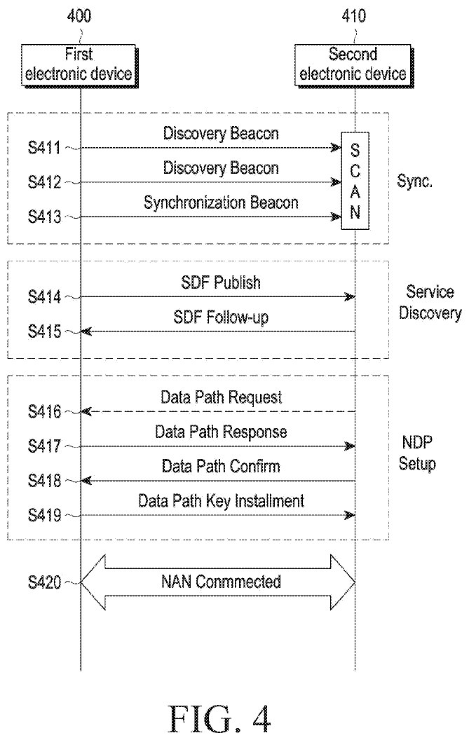

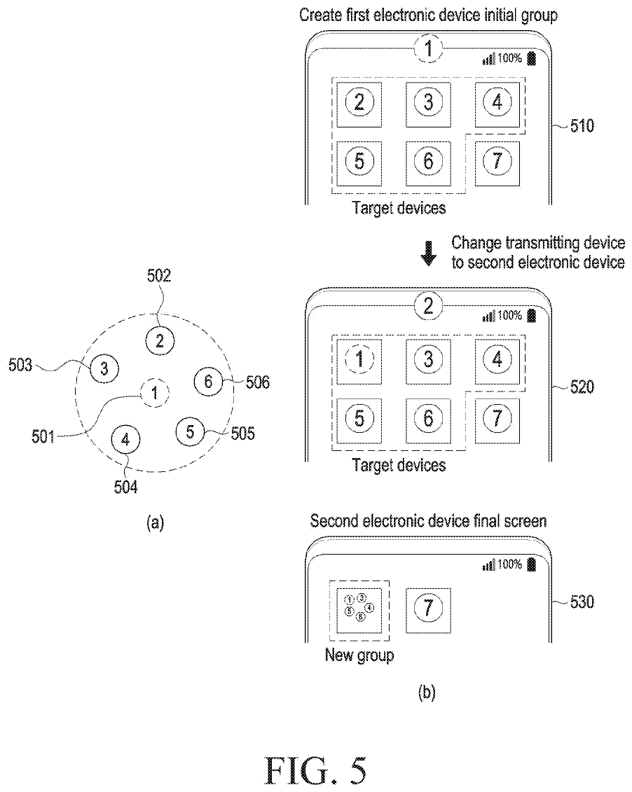

FIG. 4 illustrates operations between electronic devices for initial Wi-Fi Aware connection according to an embodiment of the disclosure.

Referring to FIG. 4, according to an embodiment, if a first electronic device 400 and a second electronic device 410 determine to proceed with Wi-Fi Aware (or NAN) connection, the first electronic device 400 may transmit a discovery beacon message to the second electronic device 410 for synchronization (S411). The discovery beacon may include at least one of a frame control (FC) field indicating the function of the signal (e.g., beacon), a broadcast address, a media access control (MAC) address of the electronic device that transmitted at least one discovery beacon, a cluster identifier, a sequence control field, a time stamp for the beacon frame, a discovery beacon interval field indicating the transmission interval of at least one discovery beacon, or capability information of the electronic device that transmitted at least one discovery beacon. According to an embodiment, at least one discovery beacon may include an information element related to at least one proximity network.

The first electronic device 400 may retransmit a discovery beacon message to the second electronic device 410 (S412).

The first electronic device 400 may transmit a synchronization beacon message to the second electronic device 410 (S413). The at least one synchronization beacon may be a signal for maintaining synchronization (e.g., time clock synchronization) between electronic devices included in a cluster. At least one synchronization beacon may include at least one piece of information involved in synchronization between electronic devices. For example, at least one synchronization beacon may include at least one of a frame control (FC) field indicating the function of the signal (e.g., beacon), a broadcast address, a media access control (MAC) address of the electronic device that transmitted at least one synchronization beacon, a cluster identifier, a sequence control field, a time stamp for the beacon frame, a beacon interval field indicating the interval between start times of synchronized communication intervals, or capability information of the electronic device that transmitted at least one synchronization beacon. At least one synchronization beacon may include an information element related to at least one proximity network and may include, e.g., service-related content that may be provided based on the proximity network. The operations of S411 to S413 may be classified as a synchronization phase.

Subsequently, the first electronic device 400 transmits a service discovery frame (SDF) publish message to the second electronic device 410 for service discovery (S414), and the second electronic device 410 may transmit an SDF follow-up message to the first electronic device 400 (S415). The operations of S411 to S413 may be classified as a service discovery phase.

The second electronic device 410 transmits a data path request message to the first electronic device 400 for NAN data path (NDP) setup (S416), and the first electronic device 400 may transmit a data path response message to the second electronic device 410(S417). The second electronic device 410 transmits a data path confirm message to the first electronic device 400(S418), and the first electronic device 400 may transmit a data path key installment message to the second electronic device 410 (S419). The first electronic device 400 and the second electronic device 410 may establish a NAN connection (S420).

FIG. 5 illustrates creating a device group for data sharing according to an embodiment of the disclosure.

The plurality of electronic devices 501, 502, 503, 504, 505, 506 illustrated in FIG. 5 may be, e.g., the electronic devices illustrated in FIGS. 1 to 4.

FIG. 5 illustrates forming a sharing group by a plurality of devices when data sharing is needed between the plurality of devices.

Referring to FIG. 5(a), a first electronic device 501 may be a transmitting device that creates an initial sharing group for data sharing and transmits data. According to an embodiment, at least one second electronic device 502, 503, 504, 505, 506 may be a receiving device that receives an initial sharing group request for data sharing. Among the at least one second electronic device 502, 503, 504, 505, 506, at least one electronic device that transmits information about ‘acceptance’ in a group creation response message may be referred to as a third electronic device. However, in an embodiment, a transmitting device may be changed after creating an initial sharing group. In other words, one of the second electronic devices 502, 503, 504, 505, 506 that were receiving devices after creating the initial sharing group may become a transmitting device.

In 1:1 data sharing between devices, a transmitting device repeatedly selected receiving devices one by one to transmit data, but when forming a group for data sharing, data may be transmitted to at least one receiving device in the group in a single operation. In an embodiment, the data transmission may use unicast/multicast transmission or Wi-Fi Aware/Direct communication, but the disclosure is not limited thereto.

FIG. 5(b) illustrates an example of a screen on an electronic device when forming a data sharing group. When a user's intention to create a group is input for at least one electronic device satisfying group creation conditions, the first electronic device 501 may create an initial group for electronic devices that received messages agreeing to group creation (510).

In an embodiment, when one electronic device 502 among the second electronic devices 502, 503, 504, 505, 506 that were receiving devices during initial group creation wants to transmit data, it may transmit data to other devices 501, 503, 504, 505, 506 in the already formed group without forming a new group (520). In this case, information about the formed group may be displayed on the screen of electronic device 502 (530).

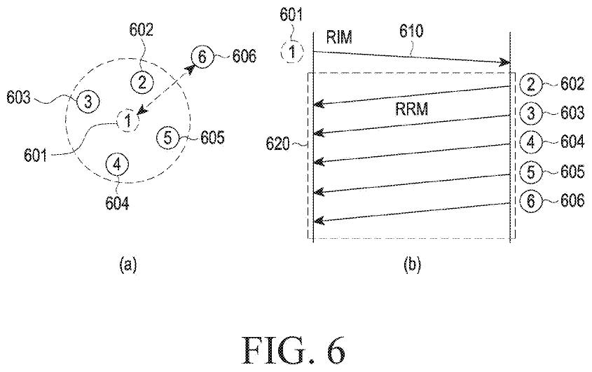

FIG. 6 is a view illustrating creating a device group for data sharing according to an embodiment of the disclosure.

The plurality of electronic devices 601, 602, 603, 604, 605, 606 illustrated in FIG. 6 may be, e.g., the electronic devices illustrated in FIGS. 1 to 5.

FIG. 6 describes group creation conditions when data sharing is needed between a plurality of devices.

Referring to FIG. 6(a), a first electronic device 601 may be a transmitting device that creates an initial sharing group for data sharing and transmits data. According to an embodiment, 2-1th electronic devices 602, 603, 604, 605 and a 2-2th electronic device 606 may be receiving devices that receive an initial sharing group request for data sharing and receive data. The 2-1th electronic devices 602, 603, 604, 605 may refer to electronic devices included within a preset boundary. The 2-2th electronic device 606 may refer to a device that is outside the preset boundary but performs intermittent ranging operations with the first electronic device 601 using UWB communication.

Referring to FIG. 6(b), in an embodiment, for the first electronic device 601 to discover devices to use for group formation, since there is no existing Wi-Fi connection, a Hyper UWB session (HUS) may be used. In an embodiment, the first electronic device 601 may transmit a contention-based ranging initiation message (RIM) to the 2-1th electronic devices 602, 603, 604, 605 and the 2-2th electronic device 606 (610). The 2-1th electronic devices 602, 603, 604, 605 and the 2-2th electronic device 606 that received the RIM may transmit a ranging response message (RRM) (620).

In an embodiment, the first electronic device 610 may secure a physical security function by limiting the distance when selecting electronic devices to form a sharing group for data sharing. For example, group sharing targets may be limited to electronic devices with ranging results within 1M. Accordingly, fake electronic devices attempting to participate in group sharing from afar may be eliminated.

In an embodiment, when the first electronic device 610 selects receiving devices to share data with and wants to create a group including electronic devices outside the boundary, the first electronic device 601 may identify whether to create a group including electronic devices outside the boundary. For example, when the first electronic device 610 wants to form a group including the 2-2th electronic device 606, a confirmation message about including the 2-2th electronic device 606 in the group may be displayed.

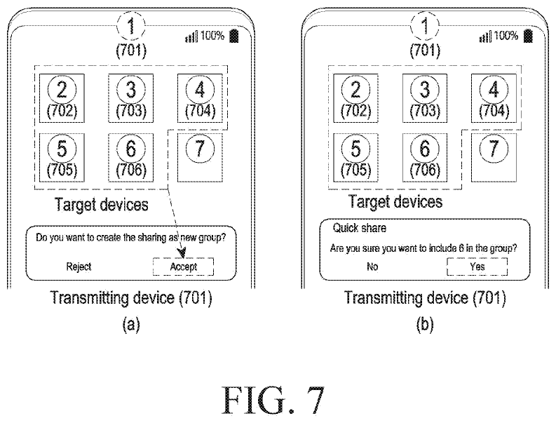

FIG. 7 is a view illustrating operations in a transmitting device when creating a sharing group for data sharing according to an embodiment of the disclosure.

FIG. 7 illustrates a screen of a transmitting device 701 that creates an initial sharing group for data sharing and transmits data among a plurality of electronic devices 701, 702, 703, 704, 705, 706. For example, the plurality of electronic devices 701, 702, 703, 704, 705, 706 in FIG. 7 may be the electronic devices illustrated in FIGS. 1 to 6.

Referring to FIG. 7(a), in an embodiment, if the first electronic device 701 receives input from a user for selection of at least one receiving device to include in a sharing group at the start of sharing group creation, it may display a consent confirmation message for group creation. In an embodiment, when the first electronic device 701 receives input for consent to sharing group creation from a user, it may transmit a sharing group electronic device list to the selected at least one electronic device.

Referring to FIG. 7(b), in an embodiment, if the first electronic device 701 receives input from a user for group creation including an electronic device outside the boundary (e.g., the electronic device 706) at the start of sharing group creation, the first electronic device 701 may identify whether to create a group including the electronic device outside the boundary.

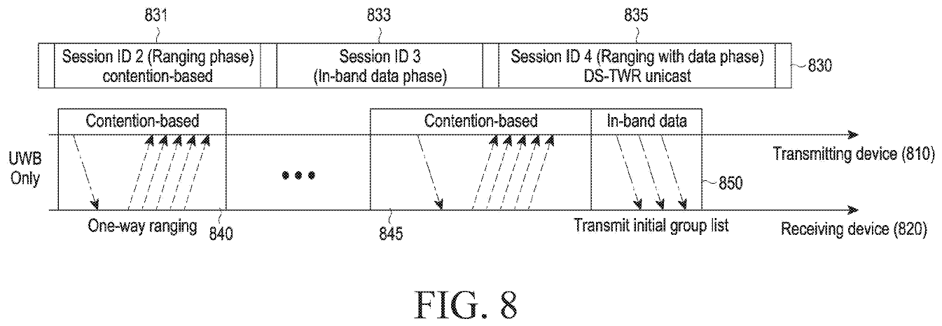

FIG. 8 is a view illustrating operations in a transmitting device and receiving device when creating a sharing group for data sharing according to an embodiment of the disclosure.

Referring to FIG. 8, a transmitting device 810 may be the first electronic device 501 illustrated in FIG. 5(a) that creates an initial sharing group for data sharing and transmits data. A receiving device 820 may include at least one of the second electronic devices 502, 503, 504, 505, 506 illustrated in FIG. 5(b) that receive an initial sharing group request for data sharing and receive data.

In an embodiment, when the transmitting device 810 receives input from a user for selection of at least one receiving device to include in a sharing group before starting group sharing, it may transmit a group creation confirmation request message to the at least one receiving device 820 and receive a group creation response message from the at least one receiving device 820. In an embodiment, when the transmitting device 810 receives input from a user for selection of at least one receiving device to transmit data to before starting group sharing, it may transmit a data reception consent confirmation message to the at least one receiving device 820 and receive a data reception consent response message from the at least one receiving device 820.

The transmitting device 810 and the receiving device 820 may send and receive messages using HUS in a state without Wi-Fi connection before sharing. In an embodiment, phases 830 within HUS for sending and receiving the messages may include, but are not limited to, session ID 2 (ranging phase) 831, session ID 3 (in-band data phase) 833, and session ID 4 (ranging with data phase) 835. The session ID 2 (ranging phase) 831 may use contention-based one-way ranging transmission. The session ID 4 (ranging with data phase) 835 may use DS-TWR Unicast.

In an embodiment, at 840, the transmitting device 810 may measure distances to the at least one receiving device 820 through contention-based one-way ranging transmission and select at least one receiving device 820 that meets sharing group conditions. In an embodiment, at 845, the transmitting device 810 may transmit a group creation confirmation request message and/or a data reception consent confirmation message to the at least one receiving device 820 through contention-based one-way ranging transmission, and receive a group creation response message and/or a data reception consent response message from the at least one receiving device 820. The group creation response message and the data reception consent response message may include information indicating ‘acceptance’ or ‘rejection’ by the at least one receiving device 820 for group creation and data reception.

In an embodiment, at 850, the transmitting device 810 may create a sharing group including at least one of the at least one receiving device 820 based on the received group creation response message and/or data reception consent response message, and transmit information about a group list created as a sharing group to the at least one receiving device 820 included in the sharing group as in-band data.

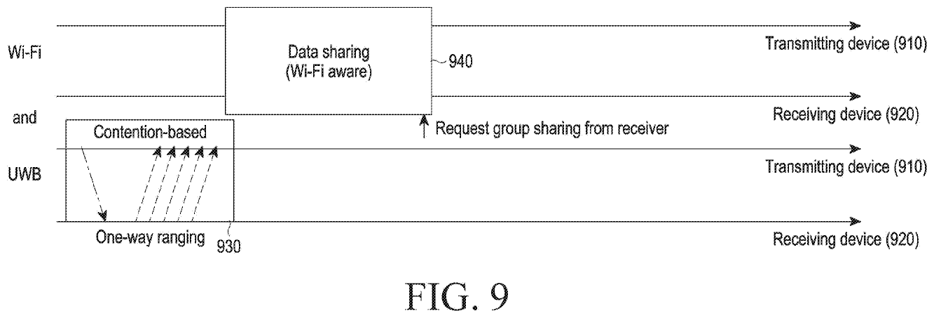

FIG. 9 is a view illustrating operations in a transmitting device and receiving device when creating a device group for data sharing according to an embodiment of the disclosure.

Referring to FIG. 9, a transmitting device 910 may be the first electronic device 501 illustrated in FIG. 5(a) that creates an initial sharing group for data sharing and transmits data. A receiving device 920 includes at least one receiving device and may include at least one of the second electronic devices 502, 503, 504, 505, 506 illustrated in FIG. 5(a) that receive an initial sharing group request for data sharing and receive data.

Referring to FIG. 9, in an embodiment, at 930, the transmitting device 910 may measure distances to the at least one receiving device 920 through contention-based one-way ranging transmission and select at least one receiving device 920 that meets sharing group conditions. Subsequently, at 940, the transmitting device 910 may transmit a group creation confirmation request message and/or a data reception consent confirmation message to the at least one receiving device 920 through Wi-Fi aware communication, and receive a group creation response message and/or a data reception consent response message from the at least one receiving device 920. In other words, referring to 845 in FIGS. 8 and 940 of FIG. 9, the transmitting devices 810, 910 may transmit a group creation response message and/or a data reception consent confirmation message to the at least one receiving device 920 through UWB communication or Wi-Fi aware communication. As illustrated in FIG. 9, when using Wi-Fi aware communication, there is an advantage that it may proceed in parallel with transmitting a group creation confirmation request message in UWB communication.

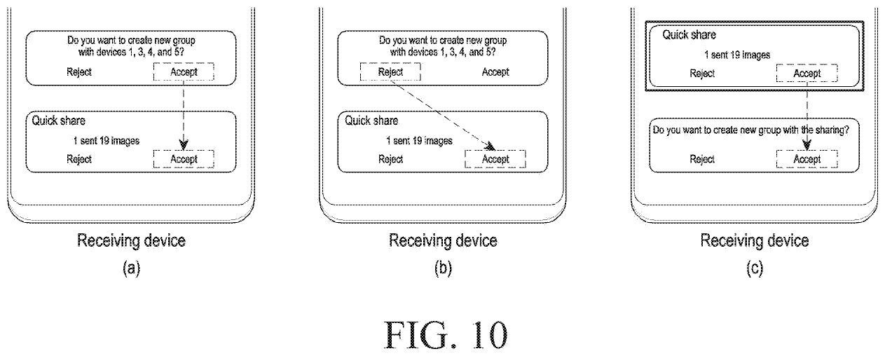

FIG. 10 is a view illustrating operations in a receiving device when creating a device group for data sharing according to an embodiment of the disclosure.

FIG. 10 illustrates a screen of a receiving device that receives a group creation confirmation request message and a data reception consent confirmation message from a transmitting device that creates an initial sharing group for data sharing and transmits data among a plurality of electronic devices. For example, the receiving device may be the receiving device 920 of FIG. 9.

FIG. 10 illustrates an example of a screen of a receiving device that has received a group creation confirmation request message and a data reception consent confirmation message from a transmitting device. In an embodiment, when the transmitting device transmits a group creation confirmation request message to the receiving device, it may provide information about other receiving devices included in the group. In an embodiment, the transmitting device may transmit a group creation confirmation request message and a data reception consent confirmation message sequentially or simultaneously. For example, the transmitting device may transmit a data reception consent confirmation message after receiving a group creation response message for a group creation confirmation request message from the receiving device.

Referring to FIG. 10(a), when a user inputs ‘accept’ for a group creation confirmation request message and inputs ‘accept’ for a data reception consent confirmation message, the receiving device may transmit a group creation response message and a data reception consent response message including information about the ‘accept’ input to the transmitting device. The group creation response message and the data reception consent response message may be transmitted sequentially or simultaneously and may be omitted. In an embodiment, when an ‘accept’ input is included in a group creation response message, the transmitting device may skip transmitting a data reception consent confirmation message and create a Wi-Fi Aware data path for data transmission.

Referring to FIG. 10(b), if a user inputs ‘reject’ for a group creation confirmation request message and inputs ‘accept’ for a data reception consent response message, the receiving device may transmit a group creation response message and a data reception consent response message including information about the ‘accept’ or ‘reject’ input to the transmitting device. When the transmitting device receives ‘reject’ information for group creation and ‘accept’ information for data reception, it may perform 1:1 data transmission without including the receiving device in the sharing group. Thus, the transmitting device may form a sharing group through the message exchange.

Referring to FIG. 10(c), the receiving device may receive a group creation confirmation request message after receiving a data reception consent confirmation message. In an embodiment, when the receiving device receives input for ‘acceptance’ of data reception consent from a user and transmits a data reception consent response message including information indicating ‘acceptance’ to a transmitting device, it may receive and display on the screen a group creation confirmation request message for a group including the receiving device.

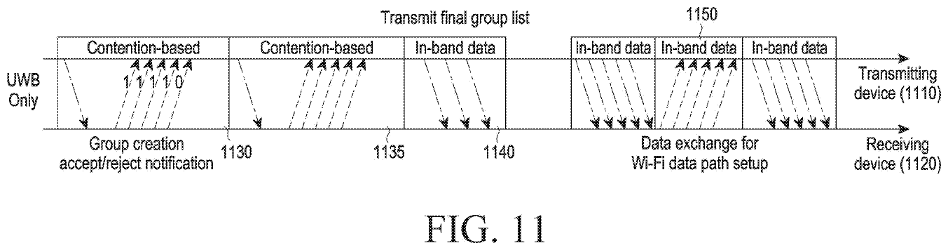

FIG. 11 is a view illustrating operations in a transmitting device and receiving device after acceptance of creation of a device group for data sharing according to an embodiment of the disclosure.

Referring to FIG. 11, a transmitting device 1110 may be the first electronic device 501 illustrated in FIG. 5(a) that creates an initial sharing group for data sharing and transmits data. A receiving device 1120 may include at least one of the second electronic devices 502, 503, 504, 505, 506 illustrated in FIG. 5(a) that receive an initial sharing group request for data sharing and receive data.

In an embodiment, when the transmitting device 1110 receives input for selection of at least one receiving device to include in a sharing group from a user before starting group sharing, it may transmit a group creation confirmation request message to the at least one receiving device 1120 and receive a group creation response message from the at least one receiving device 1120. In an embodiment, when the transmitting device 1110 receives input for selection of the receiving device to transmit data to from a user before starting group sharing, it may transmit a data reception consent confirmation message to the at least one receiving device 1120 and receive a data reception consent response message from the at least one receiving device 1120.

The transmitting device 1110 and the receiving device 1120 may send and receive messages using HUS in a state without Wi-Fi connection before sharing. In an embodiment, at 1130, the transmitting device 1110 may transmit a group creation confirmation request message to the at least one receiving device 1120 through contention-based one-way ranging transmission, and the at least one receiving device 1120 may transmit a group creation response message to the transmitting device 1110. In an embodiment, the at least one receiving device 1120 may transmit response information about ‘acceptance’ (1) or ‘rejection’ (0) for group creation included in the group creation response message. In an embodiment, at 1135, the transmitting device 1110 may transmit a data reception consent confirmation message to the at least one receiving device 1120 through contention-based one-way ranging transmission and receive a data reception consent response message from the at least one receiving device 1120.

In an embodiment, at 1140, the transmitting device 1110 may transmit information about a group list created as a sharing group to the at least one receiving device 1120 that transmitted information about ‘acceptance’ in a data reception response message among the at least one receiving device 1120 as in-band data. In an embodiment, at 1150, the transmitting device 1110 may exchange data for Wi-Fi data path setup necessary for data sharing with the at least one receiving device 1120 in the group list created as a sharing group as in-band data. The data for Wi-Fi data path setup may include information transmitted in the synchronization phase (S211 to S213) for initial Wi-Fi Aware connection illustrated in FIG. 4.

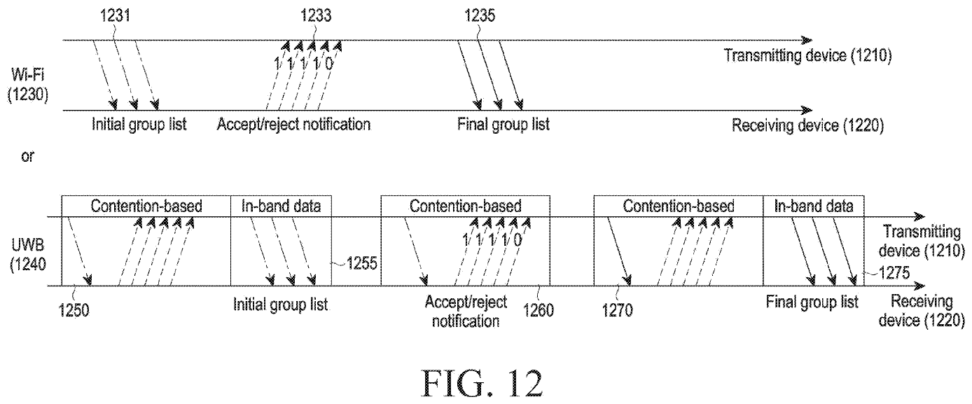

FIG. 12 is a view illustrating operations in a transmitting device and receiving device after acceptance of creation of a device group for data sharing according to an embodiment of the disclosure.

More specifically, FIG. 12 illustrates cases where the receiving device uses Wi-Fi communication and UWB HUS when transmitting a group creation response message including whether to accept sharing to a transmitting device.

Referring to FIG. 12, a transmitting device 1210 may be the first electronic device 501 illustrated in FIG. 5(a) that creates an initial sharing group for data sharing and transmits data. A receiving device 1220 may include at least one of the second electronic devices 502, 503, 504, 505, 506 illustrated in FIG. 5(a) that receive an initial sharing group request for data sharing and receive data.

Referring to FIG. 12, in an embodiment, if at least one receiving device 1220 receives a group creation confirmation request message including an initial group list from the transmitting device 1210 through Wi-Fi communication 1230 (1231), the at least one receiving device 1220 may transmit a group creation response message including response information about ‘acceptance’ (1) or ‘rejection’ (0) to the transmitting device 1210 (1233). Subsequently, the at least one receiving device 1220 with ‘acceptance’ (1) in the group creation response message may receive a final group list based on the group creation response message from the transmitting device 1210 (1235).

In an embodiment, through UWB (HUS) communication 1240, in an embodiment, at 1250, the transmitting device 1210 may transmit a group creation confirmation request message to the at least one receiving device 1220 through contention-based transmission, and the at least one receiving device 1220 may transmit a group creation response message to the transmitting device 1210. In an embodiment, the at least one receiving device 1220 may transmit response information about ‘acceptance’ (1) or ‘rejection’ (0) for group creation included in the group creation response message.

In an embodiment, at 1255, the transmitting device 1210 may transmit an initial group list as in-band data to the at least one receiving device 1220 that transmitted information about ‘acceptance’ in a data reception response message among the at least one receiving device 1220. Subsequently, at 1260, the transmitting device 1210 may transmit a group creation confirmation request message to the at least one receiving device 1220 through contention-based transmission, and the at least one receiving device 1220 may transmit a group creation response message to the transmitting device 1210. In an embodiment, the at least one receiving device 1220 may transmit response information about ‘acceptance’ (1) or ‘rejection’ (0) for group creation included in the group creation response message.

In an embodiment, at 1270, the transmitting device 1210 may transmit a group creation confirmation request message including a final group list based on the group creation response message received at 1260 to the at least one receiving device 1220 that transmitted information about ‘acceptance’ in a data reception response message among the at least one receiving device 1120, and the at least one receiving device 1220 may transmit a group creation response message to the transmitting device 1210.

In an embodiment, at 1275, the transmitting device 1210 may transmit information about a final group list based on the received group creation response message to the at least one receiving device 1220 that transmitted information about ‘acceptance’ in a data reception response message among the at least one receiving device 1220 as in-band data.

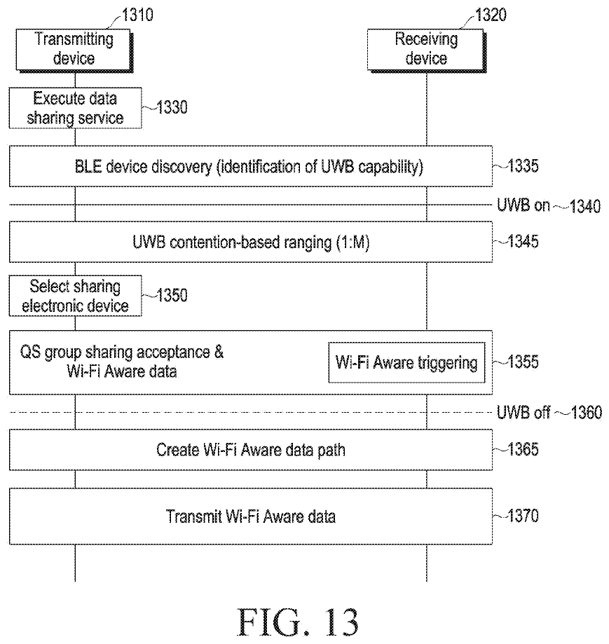

FIG. 13 is a view illustrating operations of a transmitting device and receiving device when creating a device group for data sharing and sharing data according to an embodiment of the disclosure.

Referring to FIG. 13, the transmitting device 1310 may execute a data sharing service (e.g., “Quick Share”) (1330). The transmitting device 1310 and at least one receiving device 1320 may identify UWB capability through Bluetooth device discovery (1335). In an embodiment, the transmitting device 1310 may identify the UWB capability of the at least one receiving device 1320 through beacon transmission for device discovery.

The transmitting device 1310 and the at least one receiving device 1320 may initiate a UWB communication procedure (1340). In an embodiment, the transmitting device 1310 may perform UWB contention-based ranging with the at least one receiving device 1320 (1345). The transmitting device 1310 may select an electronic device to share data with among the at least one receiving device 1320 as a result of ranging (1350). The transmitting device 1310 may form a data sharing group with the at least one receiving device 1320 selected as an electronic device to share data with, and perform a Wi-Fi Aware triggering operation for data sharing (1355). The transmitting device 1310 forming a data sharing group and performing a Wi-Fi Aware triggering operation for data sharing may be the operations 1130 to 1150 illustrated in FIG. 11. Subsequently, the transmitting device 1310 and the receiving device 1320 may terminate the UWB function (1360), create a Wi-Fi aware data path (1365), and perform Wi-Fi Aware data transmission (1370).

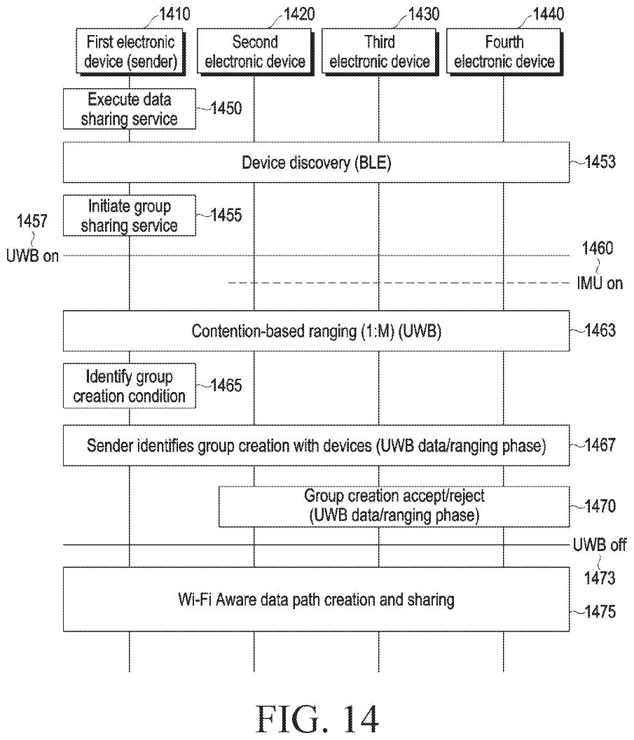

FIG. 14 is a view illustrating operations of a transmitting device and receiving device when creating a device group for data sharing and sharing data according to an embodiment of the disclosure.

Referring to FIG. 14, a first electronic device (transmitting device) 1410 is the transmitting device that transmits a group creation confirmation request message for data sharing and transmits data. A second electronic device 1420, a third electronic device 1430, and a fourth electronic device 1440 are receiving devices that receive a group creation confirmation request message for data sharing and receive data.

Referring to FIG. 14, the first electronic device (transmitting device) 1410 may execute a data sharing service (e.g., “Quick Share”) (1450). The first electronic device (transmitting device) 1410, the second electronic device 1420, the third electronic device 1430, and the fourth electronic device 1440 may identify UWB capability through Bluetooth device discovery (1453). In an embodiment, the first electronic device (transmitting device) 1410 may identify the UWB capability of the second electronic device 1420, the third electronic device 1430, and the fourth electronic device 1440 through beacon transmission for device discovery.

The first electronic device (transmitting device) 1410 may initiate a group sharing service (1455) and initiate a UWB communication procedure (1457). Further, the first electronic device (transmitting device) 1410, the second electronic device 1420, the third electronic device 1430, and the fourth electronic device 1440 may activate an inertial measurement unit (IMU) to measure the position of electronic devices along with UWB communication (1460).

In an embodiment, the transmitting device 1410 may perform UWB contention-based ranging with the at least one receiving device 1420 (1463). The transmitting device 1410 may identify electronic devices that satisfy group creation conditions among the second electronic device 1420, the third electronic device 1430, and the fourth electronic device 1440 as a result of ranging (1465). In an embodiment, the group creation condition may include a condition of being within a predetermined distance from the first electronic device (transmitting device) 1410.

In an embodiment, when the first electronic device (transmitting device) 1410 selects all of the second electronic device 1420, the third electronic device 1430, and the fourth electronic device 1440 as electronic devices to share data with, it may transmit a group creation confirmation request message to the second electronic device 1420, the third electronic device 1430, and the fourth electronic device 1440 in the UWB data/ranging phase (1467). The second electronic device 1420, the third electronic device 1430, and the fourth electronic device 1440 may transmit a group creation response message including information about ‘acceptance’ or ‘rejection’ for group creation in response to the group creation confirmation request message to the first electronic device (transmitting device) 1410 (1470).

The first electronic device (transmitting device) 1410, the second electronic device 1420, the third electronic device 1430, and the fourth electronic device 1440 may terminate the UWB function (1473), and the first electronic device (transmitting device) 1410 may create a Wi-Fi aware data path with electronic devices that transmitted a group creation response message including information about ‘acceptance’ for group creation among the second electronic device 1420, the third electronic device 1430, and the fourth electronic device 1440, and perform Wi-Fi Aware data transmission (1475).

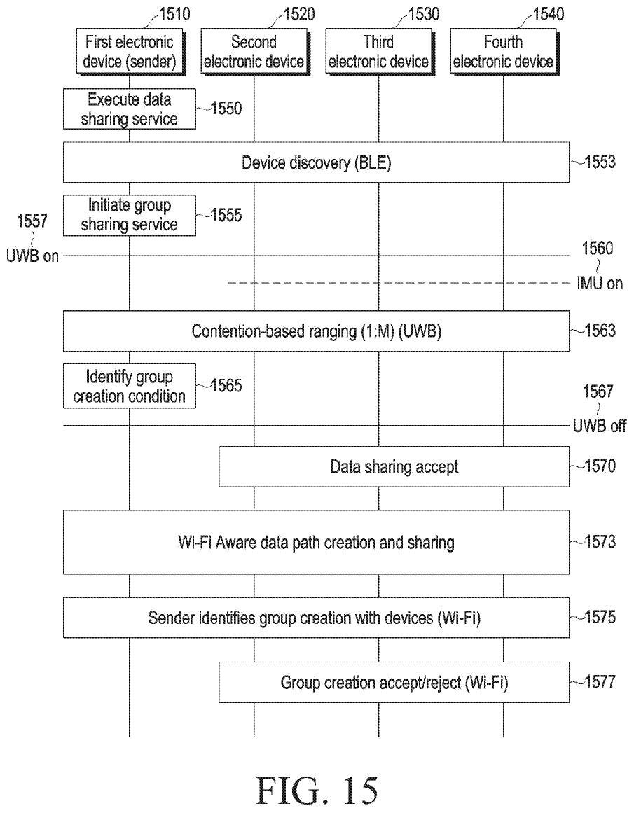

FIG. 15 is a view illustrating operations of a transmitting device and receiving device when creating a device group for data sharing and sharing data according to an embodiment of the disclosure.

Referring to FIG. 15, a first electronic device (transmitting device) 1510 is the transmitting device that transmits a group creation confirmation request message for data sharing and transmits data. A second electronic device 1520, a third electronic device 1530, and a fourth electronic device 1540 are receiving devices that receive a group creation confirmation request message for data sharing and receive data.

FIG. 15 is a view illustrating group creation operations after the first electronic device (transmitting device) 1510 transmits a data reception consent confirmation message to the second electronic device 1520, the third electronic device 1530, and the fourth electronic device 1540 and receives a data reception consent acceptance message.

Referring to FIG. 15, the first electronic device (transmitting device) 1510 may execute a data sharing service (e.g., “Quick Share”) (1550).

The first electronic device (transmitting device) 1510, the second electronic device 1520, the third electronic device 1530, and the fourth electronic device 1540 may identify UWB capability through Bluetooth device discovery (1553). In an embodiment, the first electronic device (transmitting device) 1510 may identify the UWB capability of the second electronic device 1520, the third electronic device 1530, and the fourth electronic device 1540 through beacon transmission for device discovery.

The first electronic device (transmitting device) 1510 may initiate a group sharing service (1555) and initiate a UWB communication procedure (1557). Further, the first electronic device (transmitting device) 1510, the second electronic device 1520, the third electronic device 1530, and the fourth electronic device 1540 may activate an inertial measurement unit (IMU) to measure the position of electronic devices along with UWB communication (1560).

In an embodiment, the transmitting device 1510 may perform UWB contention-based ranging with the at least one receiving device 1520 (1563). The transmitting device 1510 may identify electronic devices that satisfy group creation conditions among the second electronic device 1520, the third electronic device 1530, and the fourth electronic device 1540 as a result of ranging (1565). In an embodiment, the group creation condition may include a condition of being within a predetermined distance from the first electronic device (transmitting device) 1510.

In an embodiment, the first electronic device (transmitting device) 1510 may terminate the UWB function (1573) and, when selecting all of the second electronic device 1520, the third electronic device 1530, and the fourth electronic device 1540 as electronic devices to share data with, it may transmit a data reception consent confirmation message to the second electronic device 1520, the third electronic device 1530, and the fourth electronic device 1540. Subsequently, the first electronic device (transmitting device) 1510 may receive acceptance status from the second electronic device 1520, the third electronic device 1530, and the fourth electronic device 1540 through a data reception consent response message (1570).

The first electronic device (transmitting device) 1510, the second electronic device 1520, the third electronic device 1530, and the fourth electronic device 1540 may create a Wi-Fi aware data path and perform Wi-Fi Aware data transmission (1575). Subsequently, the first electronic device (transmitting device) 1510 may transmit a group creation confirmation request message to the second electronic device 1520, the third electronic device 1530, and the fourth electronic device 1540 through the Wi-Fi data path (1567). The second electronic device 1520, the third electronic device 1530, and the fourth electronic device 1540 may transmit a group creation response message including information about ‘acceptance’ or ‘rejection’ for group creation in response to the group creation confirmation request message to the first electronic device (transmitting device) 1510 through the Wi-Fi data path (1577).

FIG. 16 is a view illustrating operations for re-sharing data after creating a device group according to an embodiment of the disclosure.

FIG. 16 is a view illustrating the operations illustrated in FIG. 5(b) and (c). In other words, when the first electronic device 501 of FIG. 5 is the transmitting device that creates an initial sharing group for data sharing and transmits data, and at least one second electronic device 502, 503, 504, 505, 506 is the receiving device that receives an initial sharing group request for data sharing and receives data, this is a diagram for a case where the transmitting device is changed after creating an initial sharing group. In an embodiment, one of the second electronic devices 502, 503, 504, 505, 506 that were receiving devices during initial sharing group creation may subsequently become a new transmitting device.

Referring to FIG. 16, when a second electronic device becomes a new transmitting device, the new transmitting device may utilize the Wi-Fi Aware (or Direct) data path created by the new transmitting device. In other words, even when the transmitting device within a group is changed, the HUS ranging operation illustrated in FIG. 8 may be omitted. In an embodiment, FIG. 16(a) illustrates a screen on a new transmitting device when a second electronic device is a new transmitting device, and the new transmitting device may display information about the group. FIG. 16(b) illustrates a screen of the receiving device included in an existing group, and the receiving device may receive a data reception consent confirmation message for data transmitted by the new transmitting device.

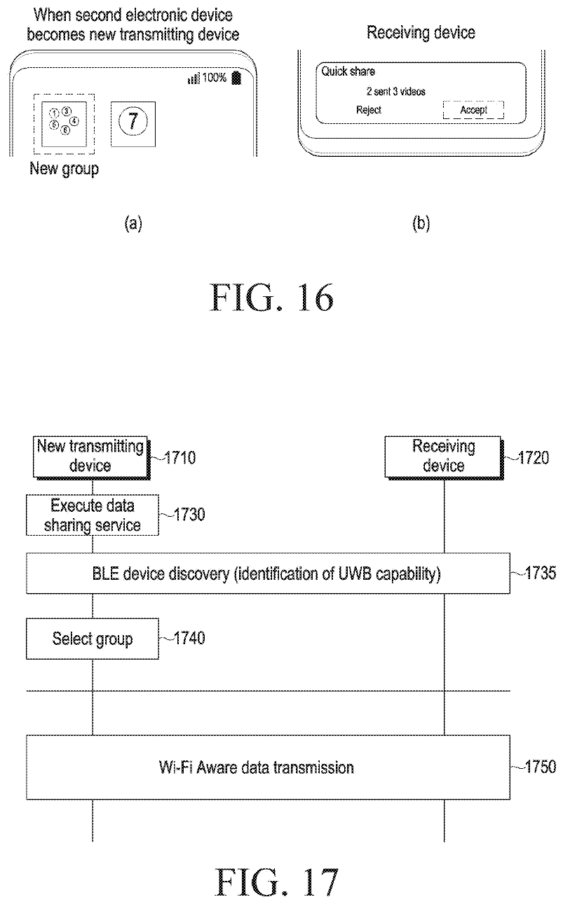

FIG. 17 is a view illustrating operations for re-sharing data after creating a device group according to an embodiment of the disclosure.

FIG. 17 is a view illustrating operations when the receiving device within a sharing group is changed to a new transmitting device after creating an initial sharing group as described in FIG. 16.

Referring to FIG. 17, a new transmitting device 1710 may execute a data sharing service (e.g., “Quick Share”) (1730).

The new transmitting device 1710 may identify UWB capability through Bluetooth device discovery (1735). In an embodiment, the new transmitting device 1710 may identify the UWB capability of at least one receiving device 1720 through beacon transmission for device discovery. The new transmitting device 1710 may select a group (1740), and in this case, may select a previously formed data sharing group. When the new transmitting device 1710 selects a previously formed data sharing group, it may omit operations of identifying group creation through UWB ranging, Wi-Fi Aware triggering, and Wi-Fi Aware data path creation, and perform Wi-Fi Aware data transmission with the at least one receiving device 1720 (1750).

In an embodiment, when a re-sharing operation by a new transmitting device is performed after a predetermined time has elapsed, some of the electronic devices set in the initial group may not satisfy the group formation conditions. In this case, if at least some electronic devices included in the initial group are present (e.g., at least 2 devices exist), the new transmitting device may display only the electronic devices included in the group in the group list. In this case, when a user selects data transmission for that group, the new transmitting device may transmit data to the electronic devices currently included in the group.

In an embodiment, when wanting to transmit data to all electronic devices included in the initial group but not existing in the group, the new transmitting device may transmit data using communication technology other than Wi-Fi (e.g., cloud, shared link, cellular, etc.).

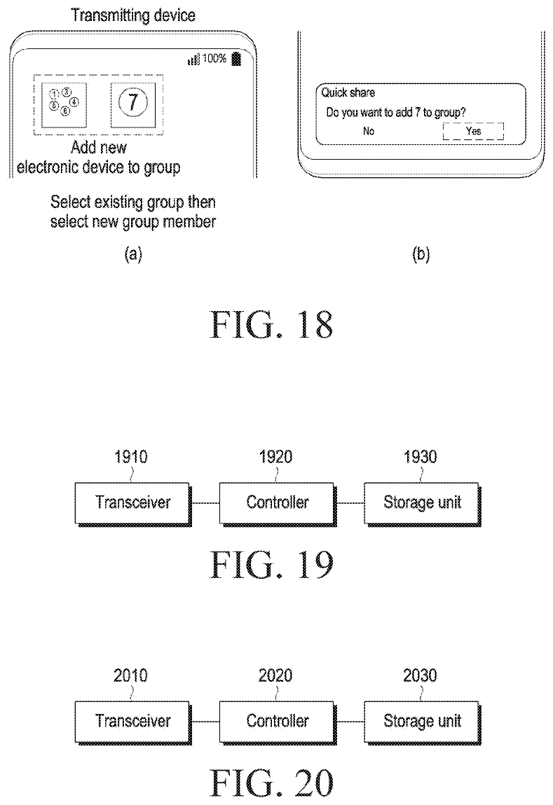

FIG. 18 is a view illustrating operations for adding a new electronic device to a group after creating a device group according to an embodiment of the disclosure.

FIG. 18 describes a case of adding a new electronic device to a group after group sharing. In other words, when one of the electronic devices currently included in a group wants to add a new electronic device to the group, adding a new electronic device may be selected. FIG. 18(a) is a screen displaying information about an existing group and new electronic devices that may be added, and although it illustrates a screen on a transmitting device, the same screen may be displayed on the receiving device included in the group.

In an embodiment, when an electronic device in a group that wants to add a new electronic device is the receiving device, it may transmit a request message for adding the new electronic device to the group to the transmitting device. FIG. 18(b) illustrates a screen displaying a message about whether the transmitting device will add a new electronic device. Subsequently, when the transmitting device receives input for adding a new electronic device from a user, it may add an electronic device to the group or create a new group including the new electronic device according to group creation conditions.

FIG. 19 illustrates the structure of a first electronic device according to an embodiment of the disclosure.

In the embodiment of FIG. 19, the first electronic device may correspond to, include, or include portion of the electronic device illustrated in FIGS. 1 to 18.

In the embodiment of FIG. 19, the first electronic device may be the transmitting device that performs sharing group creation for data sharing and data transmission illustrated in FIGS. 1 to 18.

Referring to FIG. 19, the first electronic device may include a transceiver 1910, a controller 1920, and a storage 1930. In the disclosure, the controller may be defined as a circuit or an application specific integrated circuit or at least one processor.

The transceiver 1910 may transmit and receive signals to/from another entity.

The controller 1920 may control the overall operation of the electronic device according to an embodiment. For example, the controller 1920 may control signal flow between blocks to perform operations according to the flowchart described above. Specifically, the controller 1920 may control the operations of the electronic device described above with reference to FIGS. 1 to 18.

The storage unit 1930 may store at least one of information transmitted/received via the transceiver 1910 and information generated via the controller 1920. For example, the storage unit 1930 may store information and data necessary for the method described above with reference to FIGS. 1 to 18.

According to an embodiment, the controller 1920 may be configured to select at least one second electronic device to form a group using UWB ranging, transmit a group creation confirmation request message to the at least one second electronic device using UWB communication, receive a group creation response message from the at least one second electronic device using UWB communication, create a group including at least one third electronic device that transmitted a response for acceptance based on the group creation response message, transmit information about the created group to the at least one third electronic device using UWB communication, and transmit data to the at least one third electronic device included in the created group for data sharing using Wi-Fi Aware communication.

According to an embodiment, the controller 1920 may be further configured to create a Wi-Fi Aware data path for transmitting information about the created group to the at least one third electronic device using UWB communication based on the group creation response message.

According to an embodiment, the controller 1920 may be further configured to receive data from the at least one third electronic device through the Wi-Fi Aware data path.

According to an embodiment, the controller 1920 may be further configured to transmit a data reception confirmation request message to the at least one second electronic device using UWB communication, and receive a data reception response message from the at least one second electronic device using UWB communication.

According to an embodiment, the information about the group for data sharing may include a list of the at least one third electronic device included in the group for data sharing.

According to an embodiment, selecting the at least one second electronic device to form a group using UWB ranging may be based on a distance between electronic devices measured using UWB ranging. According to an embodiment, the group creation confirmation request message may be transmitted through contention-based transmission of UWB communication, and the information about the created group may be transmitted through in-band data transmission of UWB communication.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

1. A method by a first electronic device, the method comprising:
selecting at least one second electronic device to form a group, using ultra-wide band (UWB) ranging;
transmitting, to the at least one second electronic device, a group creation confirmation request message, using UWB communication;
receiving, from the at least one second electronic device, a group creation response message in response to the group creation confirmation request message, using UWB communication;
creating a group including at least one third electronic device that has transmitted a response indicating acceptance of a group creation, based on the group creation response message;
transmitting, to the at least one third electronic device, information on a created group, using UWB communication; and
transmitting, to the at least one third electronic device included in the created group for data sharing, data, using neighbor awareness networking (NAN) based communication.

2. The method of claim 1, further comprising:
creating a NAN based data path for transmitting information on the created group to the at least one third electronic device using UWB communication, based on the group creation response message.

3. The method of claim 2, further comprising:
receiving, from the at least one third electronic device, data, through the NAN based data path.

4. The method of claim 1, further comprising:
transmitting, to the at least one second electronic device, a data reception confirmation request message, using UWB communication, and
receiving, from the at least one second electronic device, a data reception response message, using UWB communication.

5. The method of claim 1, wherein the information on the created group for data sharing includes a list of the at least one third electronic device included in the created group for data sharing.

6. The method of claim 1, wherein selecting the at least one second electronic device to form the group using UWB ranging is based on a distance between electronic devices measured using UWB ranging.

7. The method of claim 1, wherein the group creation confirmation request message is transmitted through contention-based transmission of UWB communication, and
wherein the information on the created group is transmitted through in-band data transmission of UWB communication.

8. A first electronic device comprising:
a transceiver; and
at least one processor, wherein the at least one processor is configured to:
select at least one second electronic device to form a group, using ultra wide band (UWB) ranging;
transmit, to the at least one second electronic device, a group creation confirmation request message, using UWB communication;
receive, from the at least one second electronic device, a group creation response message in response to the group creation confirmation request message, using UWB communication;
create a group including at least one third electronic device that has transmitted a response indicating acceptance of a group creation, based on the group creation response message;
transmit, to the at least one third electronic device, information on thea created group, using UWB communication; and
transmit, to the at least one third electronic device included in the created group for data sharing, data, using neighbor ness networking (NAN) based communication.

9. The first electronic device of claim 8, wherein the at least one processor is further configured to create a NAN based data path for transmitting information on the created group to the at least one third electronic device using UWB communication based on the group creation response message.

10. The first electronic device of claim 9, wherein the at least one processor is further configured to receive, from the at least one third electronic device, data through the NAN based data path.

11. The first electronic device of claim 8, wherein the controller is further configured to:
transmit, to the at least one second electronic device, a data reception confirmation request message, using UWB communication; and
receive, from the at least one second electronic device, a data reception response message, using UWB communication.

12. The first electronic device of claim 8, wherein the information on the group for data sharing includes a list of the at least one third electronic device included in the group for data sharing.

13. The first electronic device of claim 8, wherein selecting the at least one second electronic device to form the group using UWB ranging is based on a distance between electronic devices measured using UWB ranging.

14. The first electronic device of claim 8, wherein the group creation confirmation request message is transmitted through contention-based transmission of UWB communication, and wherein the information on the created group is transmitted through in-band data transmission of UWB communication.

15. A method by a second electronic device, the method comprising:
receiving, from a first electronic device, a group creation confirmation request message, using UWB communication;
transmitting, to the first second electronic device, a group creation response message indicating acceptance of a group creation in response to the group creation confirmation request message, using UWB communication;
receiving, from the first electronic device, information on a created group based on the group creation response message, using UWB communication, and
receiving, from the first electronic device, data based on information on the created group, using neighbor awareness networking (NAN) based communication.

16. The method of claim 15, further comprising:
transmitting, to the first electronic device, data, through the NAN based data path,

17. The method of claim 15, further comprising:
receiving, from the first electronic device, a data reception confirmation request message, using UWB communication; and
transmitting, to the first electronic device, a data reception response message, using UWB communication.

18. The method of claim 15, wherein the information on the created group for data sharing includes a list of at least one electronic device included in the created group for data sharing.

19. The method of claim 15, wherein the group creation confirmation request message is received through contention-based transmission of UWB communication, and
wherein the information on the created group is received through in-band data transmission of UWB communication.

20. A second electronic device comprising:
a transceiver; and
at least one processor, wherein the at least one processor is configured to:
receive, from a first electronic device, a group creation confirmation request message, using UWB communication;
transmit, to the first second electronic device, a group creation response message indicating acceptance of a group creation in response to the group creation confirmation request message, using UWB communication;
receive, from the first electronic device, information on a created group including the second electronic device based on the group creation response message, using UWB communication, and
receive, from the first electronic device, data based on information on the created group, using neighbor awareness networking (NAN) based communication.
